(19) United States
(12) Patent Application Publication
(10) Pub. No.: US 2005/0009425 A1
(43) Pub. Date: Jan. 13, 2005

(54) Disposable absorbent mat

(76) Inventor: Frederick C. Foote, Haslett, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/877,268

(22) Filed: Jun. 24, 2004

Related U.S. Application Data
(63) Continuation-in-part of application No. 10/604,294, filed on Jul. 9, 2003.

(51) Int. Cl. B32B 5/26; B32B 27/12

(52) U.S. Cl. 442/57; 442/35; 442/400; 442/401; 442/96; 428/131; 428/137; 428/138

(57) ABSTRACT

A durable, low-cost, disposable absorbent sheet construction of layers ultrasonically secured together, including a permeable top layer, an upper absorbent layer, an impermeable layer that prevents moisture passage, a lower absorbent layer, and a permeable bottom layer. The layers are ultra-sonically bonded at point locations, which provides a low-cost secure attachment and further provides an attractive pattern to the sheet. Also, the bonding forms depressions that facilitate entry of water into the absorbent layers. Repositionable adhesive on the bottom layer provides secure but repositionable attachment to a floor surface. An anti-microbial agent and/or an air freshening agent can be added to the absorbent layer as desired.

### CROSS REFERENCE TO RELATED APPLICATIONS

This application is a continuation-in-part of patent application Ser. No. 10/604,294, filed on Jul. 8, 2003, entitled DISPOSABLE ABSORBENT SHEET, the entire contents of which are incorporated herein in their entirety by reference.

### BACKGROUND OF THE INVENTION

The present invention relates to a disposable, absorbent sheet of engineered material for adhesive installation in front of urinals and toilets in public restrooms, at the bottom of small animal or bird cages, on the floors of kitchen or foodservice areas in restaurants, and other suitable locations. The invention especially relates to pads or rolls of such sheets, each pad or roll containing a plurality of sheets affixed to one another by a strip or strips of light to moderately tacky (repositionable) adhesive on the underside of each sheet in a manner analogous to the POST-IT® pads of adhesive notes commonly used to annotate office documents.

Attempts are known in the art to maintain sanitary conditions in restrooms near toilets and wall-mounted urinals using trays, mats, or sheets, particularly in public restrooms for men where unwanted moisture, odor and bacteria on the floors commonly present sanitary and aesthetic problems and potential safety risks. For example, U.S. Pat. No. 4,125,656 to Creamer shows a pleated absorbent sheet for use around the base of a pedestal toilet to absorb moisture. Unfortunately, the pleated Creamer sheet is small and only suitable to absorb condensation dripping down the sides of the pedestal of a toilet. As such, it is not at all suitable for use at a wall-mounted urinal. Further, even at the base of a toilet it is not suitable for a user to stand upon or directly over and, therefore, does not aid in collecting drips or spills attributable to the user himself or the flushing action or condensation or any other occurrence causing liquid underneath the urinal. The time-consuming and complicated pleating, folding, and adjustment features of the Creamer sheet further reduce the utility of this invention as it is expensive to manufacture and difficult to install.

Other absorbent sheets in the prior art are designed to be held within bulky, rigid trays. These trays themselves are subject to odor, moisture, and unsanitary bacteria. They are also expensive to manufacture, creating a hesitancy for consumers to dispose of the soiled tray. Also, the trays are often unattractive, particularly after extended use. Thus, they potentially do not save in cleaning time, nor do they necessarily provide the desired improved sanitary environment.

Of concern is the risk of an absorbent sheet slipping out of position while in use. Again, unsatisfactory attempts to prevent this problem exist in the prior art. Some embodiments secure a sheet or a collection of sheets through use of strings, tape, or staples. These additional materials make the sheets both more difficult to manufacture and more time-consuming to install and remove. For example, U.S. Pat. No. 2,057,162 to Richey utilizes strings to tie absorbent sheets to toilet pedestals. Not only would the Richey sheet be difficult to install, but it would be unsanitary as well since the attendant would have to reach behind the toilet to install the device.

An absorbent sheet is desired that not only prevents wetness from above from soaking through to the floor, but that also that prevents wetness from wicking upwardly from the floor onto a person's shoes or feet.

In short, there is a desire and need in the art for an absorbent sheet of engineered material for use in restrooms and elsewhere that combines the benefits of being sanitary, capable of absorbing moisture and odor (from above and/or from below), inexpensive, secure, easy to install, easy to remove, easy to manufacture, capable of containing advertising or other messages to the user, capable of incorporating material with scented or antimicrobial properties, easy to store in the form of self-contained pads or rolls of such sheets, and also providing an aesthetically pleasing appearance.

### SUMMARY OF THE INVENTION

The present invention provides for a disposable, absorbent sheet suited for use around the base of a toilet, under a urinal, at the bottom of bird or animal cages, or on the floors of kitchen or foodservice areas in restaurants, and that may be simply and effectively secured to and removed from a floor or other surface in an efficient manner by means of a light to moderately tacky (repositionable) adhesive element.

In one aspect of the present invention, an absorbent sheet construction includes a plurality of layers secured together, each providing a function. The layers include a permeable top layer, an upper absorbent layer positioned below the top layer, and an impermeable layer positioned below the upper absorbent layer that prevents moisture from passing therethrough. The layers also include a lower absorbent layer positioned below the impermeable layer for absorbing liquid, and a permeable bottom layer positioned below the lower absorbent layer for permitting liquid to flow to the lower absorbent layer. In a narrower aspect, the bottom layer includes adhesive for releasably securing the assembly to a floor surface.

In another aspect of the present invention, an absorbent sheet construction includes a plurality of layers secured together. The layers include a permeable top layer, an upper absorbent layer positioned below the top layer, and an impermeable layer positioned below the upper absorbent layer that prevents moisture from passing therethrough. The layers further include a bottom layer attached to the plurality of layers, the bottom layer including adhesive for releasably securing the plurality of layers to a floor surface.

In yet another aspect of the present invention, an absorbent sheet construction includes a plurality of layers including an outer layer, an absorbent layer, and an impermeable layer. The outer layer is positioned on the upper layer for permitting liquid flow to the absorbent layer but for resisting liquid flow from the absorbent layer. A plurality of welded locations bonds the impermeable layer to the absorbent and the outer layer in a laminar arrangement. The locations form a pattern of depressions in the outer layer and in the absorbent layer, with the depressions being adapted to funnel liquid through the outer layer and into the absorbent layer for lateral absorption within the absorbent layer. In a preferred form, the welded locations are ultrasonically-welded and form a pattern of separated spots.

An object of the present invention is to provide a mat that is low-cost enough to allow cost-effective disposal, but is of high quality and sufficient durability to provide a high-class, sanitary, and attractive appearance.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a sheet of the present invention positioned adjacent to a toilet base;

FIG. 2 is a perspective view of sheets of the present invention positioned beneath a pair of urinals;

FIG. 3 is a plan view of an embodiment of a pad of the present invention;

FIG. 4 is a perspective view of a sheet of the present invention positioned at the bottom of a small animal cage;

FIG. 5 is a perspective view of a sheet of the present invention positioned at the bottom of a bird cage;

FIG. 6 is a sectional view taken along line 6-6 in FIG. 3; and

FIGS. 7a and 7b are perspective views of an embodiment of the present invention in the configuration of a continuous roll of sheets.

FIG. 8 is a perspective view of a multi-layered mat embodying the present invention.

FIGS. 9-10 disclose a top view and a cross sectional view of the mat shown in FIG. 8.

### DETAILED DESCRIPTION OF PREFERRED EMBODIMENT

The present invention is a disposable, absorbent sheet suitable for adhesive and repositionable installation in front of urinals and toilets, at the bottom of bird or animal cages, on the floors of kitchen or foodservice areas in restaurants, and other suitable locations. In restrooms, the invention provides a remedy for unsightly and unsanitary moisture, odor, and bacteria that commonly form at the base of urinals and toilets and typically remain until the next scheduled mopping. In addition to soiling and creating an offensive odor in public restrooms, these conditions are inevitably tracked back into the more public areas they serve such as restaurants, bars, gas stations, hotel lobbies, airline terminals, offices, schoolrooms, retail spaces, nursing homes and the like. The present invention provides a low cost-per-unit solution that is securable, capable of absorbing moisture and odor, easy to install, easy to manufacture, capable of incorporating a material with scented or antimicrobial properties, and easy to store, while also providing an aesthetically pleasing appearance, and additional safety-related benefits. Yet the product has a “disposable feel” (meaning that the perceived and actual value is not so high as to inhibit the regular disposal of the soiled product). The invention's low per-unit cost, ease of installation, and ease of removal allow it to be replaced on a daily or, in some cases, on an even more frequent basis as needed.

Described in more detail below are specific embodiments of the present invention, one for use under a urinal, another for under a pedestal toilet, a third for use at the bottom of a small animal cage or bird cage, and a fourth in the configuration of a continuous roll. Under a wall-mounted urinal, the present invention may be a simple, rectangular sheet of absorbent material large enough to catch drips and spills, large enough to permit a printed message or advertising, and simple enough in shape (i.e., no tapering or cut-outs) to make it easy and inexpensive to manufacture. It preferably is highly-absorbent and, further, may be scented, may be infused with an antimicrobial material, and may be textured and/or printed so as to conceal stains or drips. A single adhesive strip on the underside of each sheet may run the width of the sheet and be positioned on the edge of the sheet farthest away from the restroom wall. Other embodiments of the invention could have the adhesive strip in any desired pattern, such as at both ends (or even complete coverage) of the absorbent sheet.

An alternate embodiment for use at the base of a pedestal toilet would further include a cut-out to allow the sheet to extend around the pedestal and thus further underneath the bowl of the toilet.

An alternate embodiment for use at the bottom of a small animal or bird cage could also include additional adhesive elements as friction may be applied anywhere on the sheet rather than primarily along one edge.

An alternate embodiment for use as an absorbent runner on the floors of kitchen or foodservice areas in restaurants would include adhesive elements on both sides of a large, continuous roll of absorbent material.

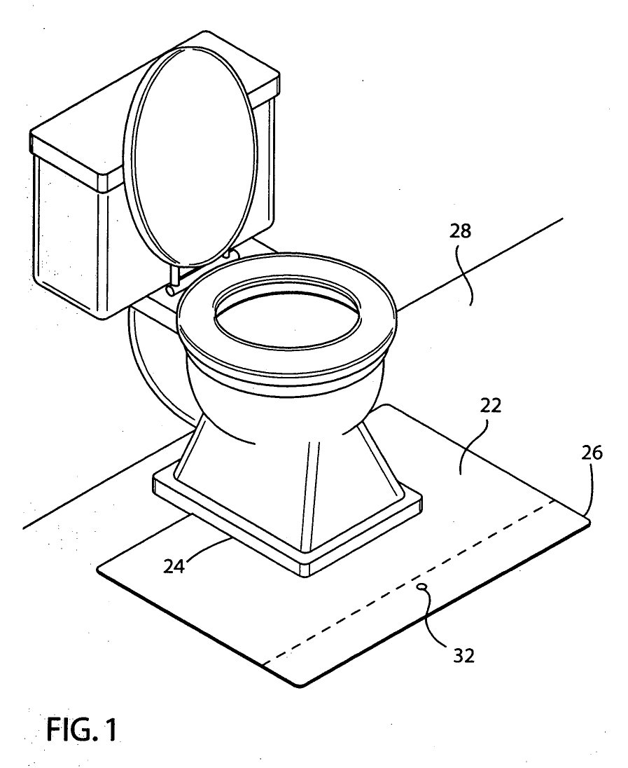

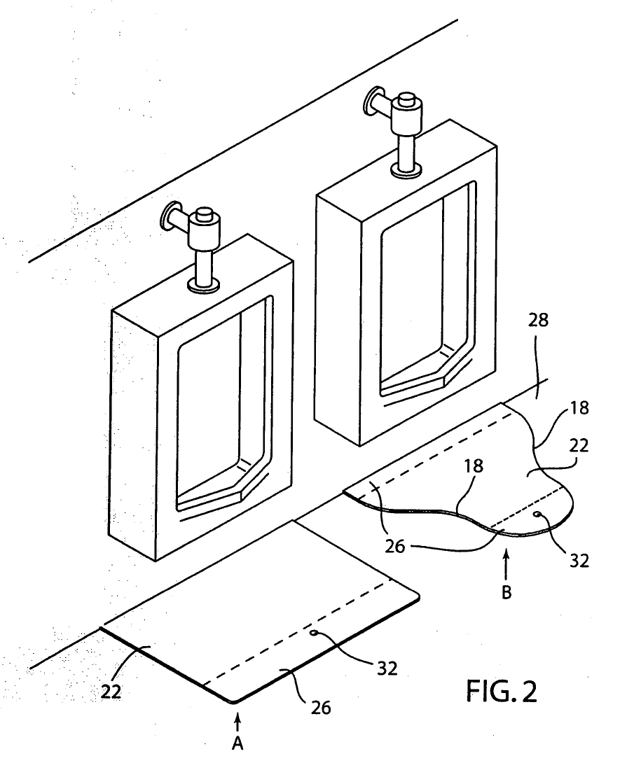

Referring specifically to the figures, embodiments of the present invention are illustrated in use under a pedestal toilet (FIG. 1) and a wall-mounted urinal (FIG. 2). In each case, a sheet 22 may be positioned adjacent to a toilet or urinal. The sheet 22 may be made of a variety of different materials including various grades of absorbent and resilient engineered material. Single or multi-ply absorbent engineered materials, with or without a non-absorbent (waxy) backing, and with or without infused odor-absorbing materials or antimicrobial materials may be utilized. Further, the thickness and degree of absorbency of the material used may vary depending on the needs and desire of the user. Accordingly, the term sheet as used herein is intended to be broadly interpreted.

As shown, sheet 22 may be configured in a variety of different shapes and sizes to accommodate the use in front of different toilet and urinal configurations. For example, FIG. 1 shows a rectangle having a cut-out 24. In FIG. 2, two embodiments of sheet 22 are shown, a rectangular shaped embodiment indicated at A and an embodiment with external cut-outs 18 indicated at B. In the embodiment of FIG. 2B, the user is not intended to have his feet contact sheet 22. Therefore, dirt and soils transferred from users will accumulate at a reduced rate and may increase the usable life of sheet 22.

In all embodiments of the present invention, sheet 22 includes an adhesive element 26 on a bottom surface such as an adhesive strip along an edge of sheet 22 as shown in the figures. Adhesive element 26 may be any material having a light to moderate tackiness capable of both holding each sheet securely to a floor surface 28 and to an adjacent sheet in a pad as described below, while also allowing easy installation, repositioning, and removal. In a preferred embodiment, adhesive element 26 runs the entire length of one edge as shown in FIG. 1. The adhesive element 26 may be approximately 5.1 cm to 12.7 cm (2 inch to 5 inches) in width. Alternatively, the adhesive element 26 may be located under any of the peripheral edges, around the entire periphery of the sheet, or even under the entire underside of sheet 22, in any pattern desired.

Adhesive element 26 enables sheet 22 to be secured to the floor surface 28 to reduce the chance of a sheet 22 slipping out of position while in use and thereby preventing a littered and unsightly appearance. Using adhesive element 26, sheets 22 are easily installed, easily removed, and easily suited for use on a variety of surfaces including metal or glass (in the case of animal cages), tile, concrete, wood, or even carpeted floors.

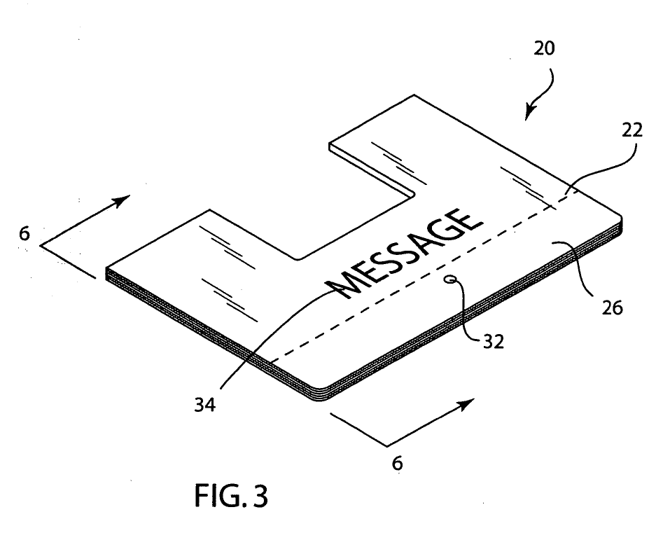

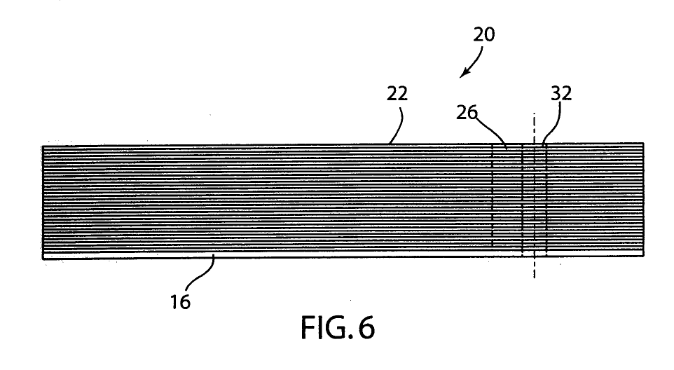

Adhesive element 26 also enables a plurality of sheets 22 to be adhesively and releasably connected vertically on top of one another to form pad 20 as shown in FIGS. 3 and 6. Again, this would be a similar configuration to the sheets of paper in a POST-IT® note pad. Each sheet 22 is individually peeled off pad 20 as needed. As shown in FIG. 6, a base sheet 16 may be included and adhesively affixed to the bottommost sheet 22 in pad 20. Base sheet 16 may be constructed of the same material as sheets 22 or other suitable materials such as a wax paper to cover and protect the adhesive element 26 on the bottommost sheet 22 of pad 20.

Sheet 22 and a resultant pad 20 may also include a hole 32 as shown in the figures. Hole 32 permits pad 20 to be stored vertically on a hook or peg. Multiple pads 20 may be stacked vertically or horizontally in a storage area, or alternatively may be hung on a peg or hook in a storage room or other location convenient for use near a toilet or urinal. This improved storageability over separate and loose sheets prevents possible damage by individual sheets falling off a shelf within a storage area or facility or by the individual sheets otherwise becoming disheveled.

Sheet 22 may also include decorative graphics or text to provide a more aesthetically pleasing appearance. For example, printed colors or geometric or swirling patterns that help hide drips and stains may improve the overall appearance of sheets 22 before, during, and after use. As shown in FIG. 3, a message 34, such as the name of the product itself or the establishment utilizing the product (e.g., the name of a hotel or restaurant chain) may also be printed on a top surface of sheets 22. Sheet 22 may also include other desirable features such as infused fragrance or antimicrobial chemicals (not shown).

In use, as shown in FIGS. 1 and 2, a single sheet 22 may be peeled from pad 20 and positioned adjacent to a urinal or toilet to provide a means to absorb fluids that may drip or splash from the toilet or urinal (in the flushing process) or from the user himself. As the sheet 22 becomes soiled, it may be easily removed from the floor surface 28 and disposed. A clean sheet 22 may then be peeled from pad 20 and positioned on floor surface 28. This process may continue until all of the plurality of sheets 22 in pad 20 have been depleted.

Sheet 22 is superior to known prior art absorbent sheets for bathrooms in that it requires no separate strips, pleats, staples, ties, or fasteners to attach it to a floor surface 28. It is contemplated that an adhesive could be used that resists damage from water, such that the present sheet could be laid onto a wet floor and, after the moisture is sufficiently absorbed by the sheet or evaporated, the adhesive would bond to the floor surface and anchor the sheet.

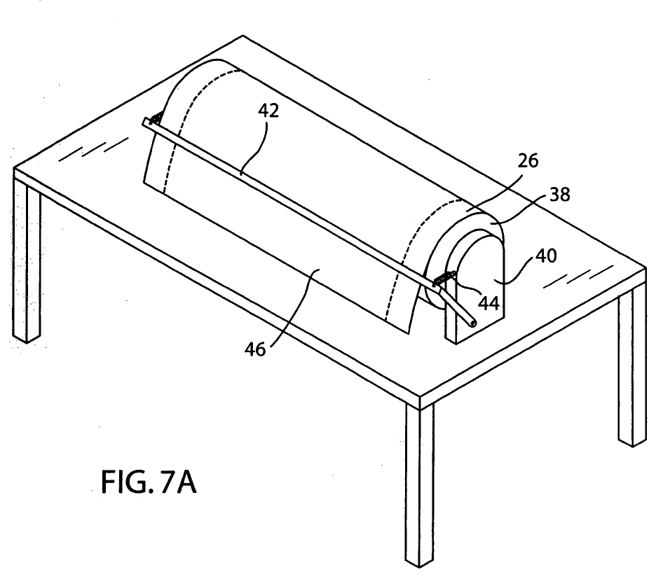

In another embodiment of the present invention, a longer and wider sheet 22 is provided that is suitable, for instance, in restaurant kitchens or food service areas as an absorbent runner. In this situation, the sheet 22 may be configured from a continuous roll of absorbent material 38 as shown in FIGS. 7a and 7b. In this embodiment one or both edges of the roll of absorbent material 38 (or the entire underside in a patterned fashion) may include adhesive element 26 in the form of an adhesive strip. The roll of absorbent material 38 may be placed on a spool dispenser 40 or one similar to a dispenser of paper towels. Spool dispenser 40 may be mounted on a wall (FIG. 7b) or alternatively placed or attached on a surface such as a table top (FIG. 7a). Spool dispenser 40 may also include a cutting edge 42 and a pair of springs 44. A user may pull on the exposed end of the roll 38 until a desired section 46 of absorbent material is obtained, and then cut section 46 with cutting edge 42. Springs 44 impress cutting edge 42 upon the roll of absorbent material 38. Therefore as sections 46 are removed, cutting edge 42 applies consistent pressure upon the increasingly smaller roll of absorbent material 38.

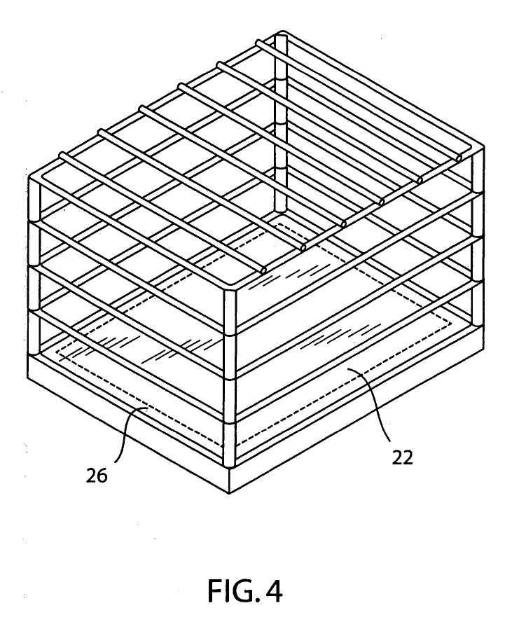

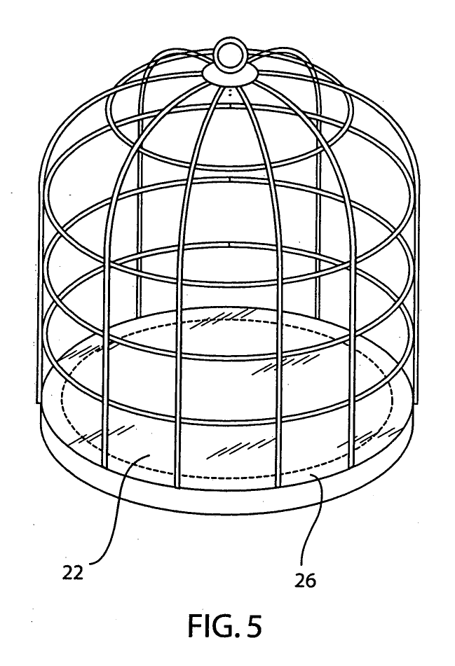

Other applications may include the use of sheets 22 for small animal cages (as illustrated in FIG. 4), bird cages (as illustrated in FIG. 5), shop table tops, temporary automobile mats (for use at detail shops, car washes, car dealership showrooms, oil change businesses, etc.), photocopy repair (where photocopy toner could soil the floor of an establishment where a photocopier is being repaired), kitchen floors and foodservice areas of restaurants, and any other place where a user would benefit from the quick installation and removal (and repositionability) afforded by a strip (or strips) of light to moderately tacky (repositionable) adhesive element 26 on an absorbent sheet 22 of engineered material where standing liquid spills are common.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

### Modification

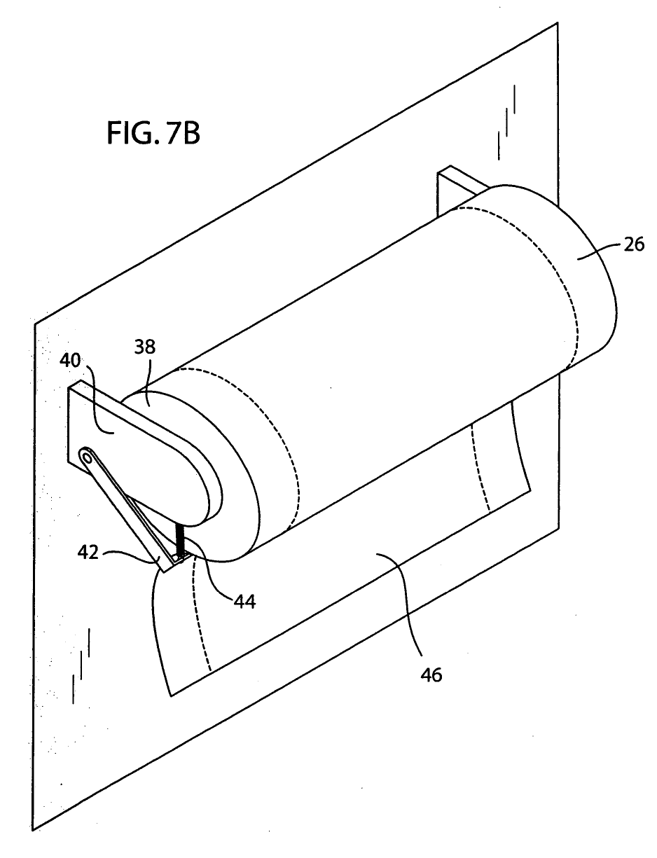

A preferred sheet construction 60 (FIG. 8) includes multiple layers 61-65, each providing a different function. The illustrated construction 60 described below is well suited for bathrooms and high foot traffic areas, though it is not believed to be limited to only those applications. Advantageously, the layers provide for absorption of moisture from above and below, while preventing the complete flow of liquid downwardly (or upwardly) through the mat. At the same time, the construction 60 is very durable. Further, the construction resists backflow of liquid, and hence resists the flow of absorbed liquid out of the mat. It is specifically contemplated that a variety of different materials can be used in the present construction, depending upon the functional and design criteria of particular applications, while still being within a scope of the present invention.

The illustrated top layer 61 is a 1.9 mil black textured apertured film (such as VISPORE, made by Tredegar, a Pennsylvania company) designed to pass moisture and to assist in quickly wicking away any drops of moisture from above. It includes perforations allowing moisture to flow into layer 62. It further provides for indentations caused by heat fusing or ultrasonic fusing methods of securing the multiple layers 61-65 together. As discussed below, the indentations allow for horizontal absorption of fluid that falls into them. The indentations also form pockets that facilitate downward flow of moisture and liquid while inhibiting reverse flow of the moisture and liquid. Preferably, the layer 61 provides a clean professional appearance, yet it is textured enough to hide drips, stains, scuffs, and surface imperfections. At the same time, it is made smooth enough to legibly receive printed or embossed images, letters, pictures, and/or messages. The layer 61 can be made any color desired.

The illustrated second layer 62 is a 2.0 oz. anisotropic layer of non-woven melt-blown polypropylene filter material forming a hydrophilic media (i.e., having an affinity for water) designed to be the principal layer for absorbing and holding moisture from above. It also can include anti-microbial agents to prevent the breakdown of urine, thus reducing odors, and also can include scents or air fresheners as desired. A preferred base weight is 68 gsm.

The illustrated third layer 63 is an impermeable layer of polyfilm (such as polypropylene, polyethylene, co-polymer polypropylene, or a polyolefin blend) designed to prevent moisture from reaching the bathroom floor. It also prevents moisture from wicking upwardly from the floor onto a person's shoes or feet. A preferred material of layer 63 has a good ultimate tensile strength such as 6100 psi and good elongation such as 750%.

The illustrated fourth layer 64 is a 1.0 oz. melt-blown polypropylene designed to absorb any pre-existing moisture up from the bathroom floor. Layer 64 is similar to layer 62 in function, construction, and material. A preferred material of layer 64 is an anisotropic layer of non-woven melt-blown, polypropylene filter material and forms a hydrophilic media. The layer 64 can have a reduced weight as compared to layer 62, such as 34 gsm base weight.

The illustrated fifth layer 65 is a hydrophilic spunbond non-woven polypropylene scrim which holds a tack-type repositionable adhesive for permitting the sheet construction 60 to be secured in a selected location and also to other sheets of like construction in a pad of such sheets. It is contemplated that the adhesive will be applied in an appropriate pattern as noted above, such as a diagonal array of spots, a crisscrossed pattern of lines, or parallel side-to-side stripes. Preferably, the rear edge of the sheet construction 60 does not include adhesive, so that individual sheets 60 can be more easily removed from a plurality of the sheets stacked together in a pad for compact shipment and storage. Also, the lack of adhesive along the rear edge allows the mat to be more easily removed from a bathroom floor. Notably, people are not likely to stand on the rear edge of the mat, such that there is a lesser need for adhesive along the rear edge. The layer 65 preferably has a base weight of about 15 gsm and an elongation of about 60%.

The layers 61-65 are suitably secured together, such as by thermal or ultrasonical bonding at point locations forming a pattern on the mat. Alternatively, the layers 61-65 can be interconnected by other means,,such as by adhesive, mechanical fasteners, stitching, needling (i.e., pushing a strand portion of one material through other layers), and the like. In a preferred form, the layers 61-65 are sufficiently similar materials to allow good bonding and have similar melting points to facilitate ultrasonic welding, as discussed below.

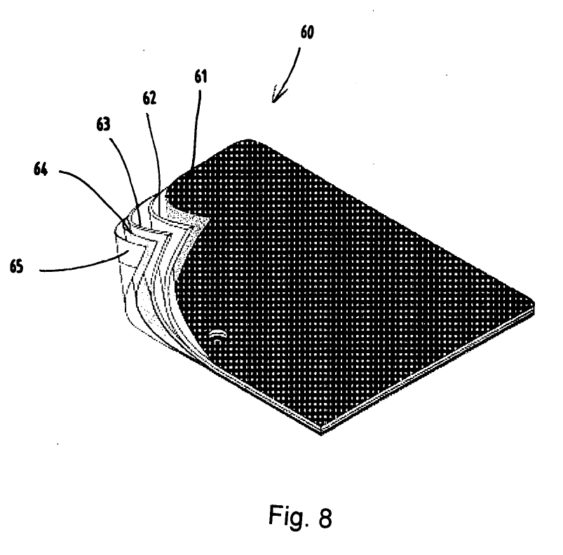

In the preferred mat construction 60, the layers 61-65 are bonded together ultrasonically at bonded locations 70 in a unique manner that both assists in one-directional wicking of liquid, and also that provides both an attractive unique appearance and secure assembly. FIG. 9 illustrates a pattern found to be particularly functional. The locations 70 are each preferably about 1/16th inch in diameter, but it is contemplated that they can be slightly more or slightly less. They are preferably spaced apart about 3/16 inch (or slightly more or less), and are preferably arranged in diagonally crisscrossing lines, with the exception that a repeated pattern of diamond-shaped areas 74 are left without any weld locations 70.

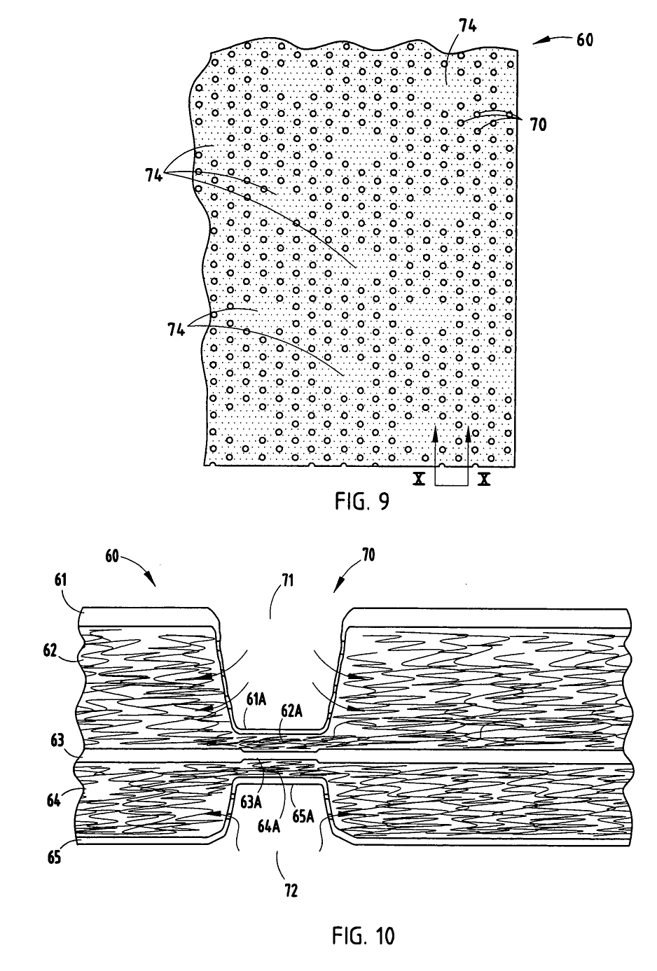

The bond locations 70 (FIG. 10) include small round sections 61A-65A from each of the layers 61-65 that are pressed together and then ultrasonically welded. It is preferable that the various layers 61-65 have melting points that are relatively close in temperature, since this assists in making consistent, reliable, and strong bonds. The ultrasonic process causes a funnel-shaped (almost cylindrically shaped) pocket or depression 71 to be formed above the layer 63 and also causes another funnel-shaped pocket or depression 72 to be formed below the layer 63. The layers 61 and 65 are stretched during this process, but enough material remains around the pockets 71 and 72 to secure the layers 61-65 together even though the sections 61A-65A (especially sections 61A and 65A) are spaced from the layers 61 and 65. Preferably, the center barrier layer 63 is not pierced, although some minor perforations and imperfections are not believed to be problematic and do not unacceptably degrade performance of the mat. The funnel-shaped pockets 71 and 72 have side-walls that are discontinuous and permeable, such that the edge of the absorbent layer 62 is directly exposed to any moisture in the pocket 71 and quickly wicks it away from the pocket 71. Specifically, liquid that drops onto the mat tends to rapidly drop to a bottom of the pocket 71 and/or be drawn into the pocket by wicking. As it enters the pocket 71, the exposed edges of the layer 62 almost immediately draw the liquid away from the pocket 71, thus allowing additional to follow entrance into the pocket. This action (in addition to the properties of the perforated apertured film 61) also hinders backflow of any liquid. The same principles apply to the pocket 72 and associated layers 63-65. Notably, the illustrated pocket 72 is somewhat shallower than pocket 71, but it should be understood that their depth, size, and structure can be varied depending upon particular functional requirements of the mat.

By this arrangement, the sheet 60 provides a three-dimensional textured appearance that hides drips, scuffs, color and surface imperfections, and many other variations in product appearance that may be undesirable. The arrangement of bonding is secure and low cost, and yet functionally provides and assists in assuring a one-way-only flow of liquid into the mat. The ultra-sonic welding is low cost and secure, and is even more secure and consistent when the material of the layers 61-65 are similar in their melting points and properties. However, the ultra-sonic welding is able to bond a wide variety of different materials, as is known in the art.

The above description is considered that of the preferred embodiments only. Modifications of the invention will occur to those skilled in the art and to those who make or .use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. An absorbent sheet construction comprising:
a plurality of layers secured together, the layers including a permeable top layer, an upper absorbent layer positioned below the top layer, an impermeable layer positioned below the upper absorbent layer that prevents moisture from passing therethrough, a lower absorbent layer positioned below the impermeable layer for absorbing liquid, and a permeable bottom layer positioned below the lower absorbent layer for permitting liquid to flow to the lower absorbent layer.

2. The absorbent sheet construction defined in claim 1, wherein the bottom layer includes a repositionable adhesive on an outward surface for releasably and repositionably securing the sheet construction to a floor surface.

3. The absorbent sheet construction defined in claim 2 wherein the adhesive is applied in a pattern to the bottom layer except along a rear edge of the bottom layer.

4. The absorbent sheet construction defined in claim 1, wherein the layers are bonded together to form a unitary assembly.

5. The absorbent sheet construction defined in claim 4, including ultrasonically-bonded material in at least two of the layers that secures the plurality of layers together in a unitary assembly.

6. The absorbent sheet construction defined in claim 5, wherein the ultrasonically-bonded material includes bonded material from each of the layers.

7. The absorbent sheet construction defined in claim 4, including an adhesive securing the plurality of layers together to form a unitary assembly.

8. The absorbent sheet construction defined in claim 1, including an anti-microbial agent in at least one of the absorbent layers to prevent the breakdown of urine by odiferous microbes.

9. The absorbent sheet construction defined in claim 1, including an air freshener in one or both of the absorbent layers.

10. The absorbent sheet construction defined in claim 1, wherein the top layer is apertured to permit moisture penetration from above.

11. The absorbent sheet construction defined in claim 10, wherein the upper absorbent top layer includes recesses aligned with the apertures allowing moisture to drop quickly into the upper absorbent layer and then flow laterally into the upper absorbent layer.

12. The absorbent sheet construction defined in claim 1, wherein the upper absorbent layer is a hydrophilic melt-blown polypropylene designed to be the principal layer for absorbing and holding moisture from above.

13. The absorbent sheet construction defined in claim 1, wherein the impermeable layer is made of durable polymeric material designed to prevent moisture from reaching a bathroom floor.

14. The absorbent sheet construction defined in claim 1, wherein the lower absorbent layer is a hydrophilic melt-blown polypropylene designed to be the principal layer for absorbing and holding moisture from below.

15. The absorbent sheet construction defined in claim 1, wherein the bottom layer is a hydrophilic spunbond polypropylene scrim.

16. An absorbent sheet construction comprising:
a plurality of layers secured together, the layers including a permeable top layer, an upper absorbent layer positioned below the top layer, an impermeable layer positioned below the upper absorbent layer that prevents moisture from passing therethrough; and
a bottom layer attached to the plurality of layers, the bottom layer including repositionable adhesive for releasably securing the plurality of layers to a floor surface.

17. The absorbent sheet construction defined in claim 16, wherein the adhesive is applied in a pattern to the bottom layer except along a rear edge of the bottom layer.

18. The absorbent sheet construction defined in claim 16, wherein the layers are bonded together to form a unitary assembly.

19. The absorbent sheet construction defined in claim 18, including ultrasonically-bonded material in at least two of the layers that secures the plurality of layers together in a unitary assembly.

20. The absorbent sheet construction defined in claim 19, wherein the ultrasonically-bonded material includes bonded material from each of the layers.

21. The absorbent sheet construction defined in claim 18, including an adhesive securing the plurality of layers together to form an assembly.

22. The absorbent sheet construction defined in claim 16, including an anti-microbial agent in at least one of the absorbent layers to prevent the breakdown of urine by odiferous microbes.

23. The absorbent sheet construction defined in claim 16, wherein the top layer is an apertured film designed to instantly wick away any drops of moisture from above.

24. The absorbent sheet construction defined in claim 16, wherein the bottom layer is a hydrophilic spunbond polypropylene scrim.

25. An absorbent sheet construction comprising:
a plurality of layers including an outer layer, an absorbent layer, and an impermeable layer, the outer layer being positioned on the upper layer for permitting liquid flow to the absorbent layer but for resisting liquid flow from the absorbent layer; and
a plurality of welded locations bonding the layers in a laminar arrangement, the locations forming a pattern of depressions in the outer layer and in the absorbent layer, the depressions being adapted to funnel liquid through the outer layer and into the absorbent layer for lateral absorption within the absorbent layer.

26. The absorbent sheet construction defined in claim 25, wherein the welded locations are ultrasonically-welded spots of less than about ⅛ inch (3 mm) in diameter and are each located within an inch of another one of the ultrasonically-welded spots.

27. The absorbent sheet construction defined in claim 25, wherein the welded locations form a pattern of spots each having a diameter of less than about 1 /16 inch (1.5 mm).

28. The absorbent sheet construction defined in claim 25, wherein the welded locations form a pattern where each location is less than a half inch from another one of the locations.
